(19) United States
(12) Patent Application Publication
(10) Pub. No.: US 2015/0185880 A1
(43) Pub. Date: Jul. 2, 2015

(54) FINGER-MOUNTED TOUCH PANEL ACTUATOR

(71) Applicant: CHIUN MAI COMMUNICATION SYSTEMS, INC., New Taipei (TW)

(72) Inventors: HOW-WEN CHIEN, New Taipei (TW); BO-HAN CHU, New Taipei (TW); KUI-HAO CHANG, New Taipei (TW)

(73) Assignee: CHIUN MAI COMMUNICATION SYSTEMS, INC., New Taipei (TW)

(21) Appl. No.: 14/570,061

(22) Filed: Dec. 15, 2014

(30) Foreign Application Priority Data
Dec. 27, 2013 (CN) 201310732302.3

(51) Int. Cl. G06F 3/0354; G06F 3/041

(52) U.S. Cl. CPC G06F 3/03545; G06F 3/041

(57) ABSTRACT

A finger-mounted touch panel actuator includes a sleeve, at least one protrusion and a vibrator configured to selectively vibrate the sleeve. The sleeve includes an inner surface and an outer surface. The at least one protrusion extends from the outer surface of the sleeve. The sleeve is wearable by a user of the touch panel and the user may selectively touch the touch panel with the at least one protrusion. The vibrator vibrates the sleeve in response to a vibrating signal.

### FIELD

The subject matter herein generally relates to fingerstalls, and particularly to a finger-mounted touch panel actuator.

### BACKGROUND

With the development of communication technology, more and more electronic devices, such as mobile phone and tablet computer, with touch panels, are widely used. A user can activate the touch panel by the fingers. When the on-screen keys are small, a stylus is typically used to replace the figure for preventing the incorrect operation of the finger. However, the stylus is inconvenient for hold.

### BRIEF DESCRIPTION OF THE DRAWINGS

Implementations of the present technology will now be described, by way of example only, with reference to the attached figures.

FIG. 1 is an isometric view of a finger-mounted touch panel actuator according to a first embodiment.

FIG. 2 is a diagrammatic view of a portable electronic device employing the finger-mounted touch panel actuator as shown in FIG. 1.

FIG. 3 is an isometric view of a finger-mounted touch panel actuator according to a second embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

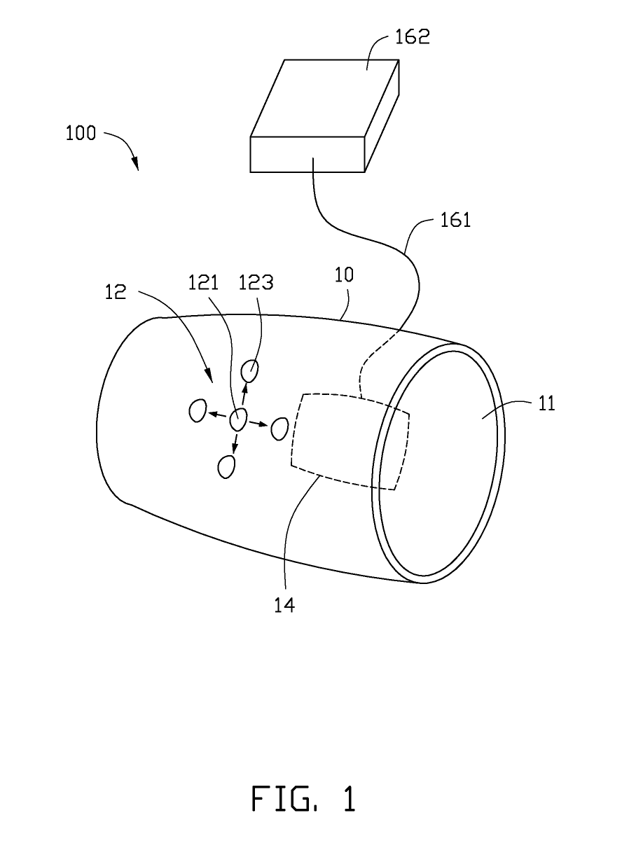

FIG. 1 illustrates an isometric view of one embodiment of a finger-mounted touch panel actuator 100. The finger-mounted touch panel actuator 100 includes a sleeve 10 with and inner surface and an outer surface, and at least one protrusion 12 protruding from an outer surface of the sleeve 10. The sleeve 10 is wearable by a user of the touch panel and the user may selectively touch the touch panel with the at least one protrusion 12. The sleeve 10 defines an entrance 11 configured to allow the sleeve 10 to cover a fingertip of the user.

The at least one protrusion 12 is configured to touch the touch panel to input predetermined operation. In at least one embodiment, the at least one protrusions 12 includes a first protrusion 121 and four second protrusions 123. The second protrusions 123 surround the first protrusion 121, and are arranged into a square. The first protrusion 121 is centrally located in the square. Two of the four second protrusions 123 are located transversely with respect to the sleeve 10, the other two of the four second protrusions 123 are located longitudinally with respect to the sleeve 10. Accordingly, by the above arrangement of the first and second protrusions 121 and 123, the first and second protrusions 121 and 123 can cooperatively serve as a direction instructing switch (cross key) of a game apparatus when the finger-mounted touch panel actuator 100 operates a touch panel that displays a game interface.

In at least one embodiment, the first and second protrusions 121 and 123 are made of elastic conductive material, such as conductive rubber or fabric.

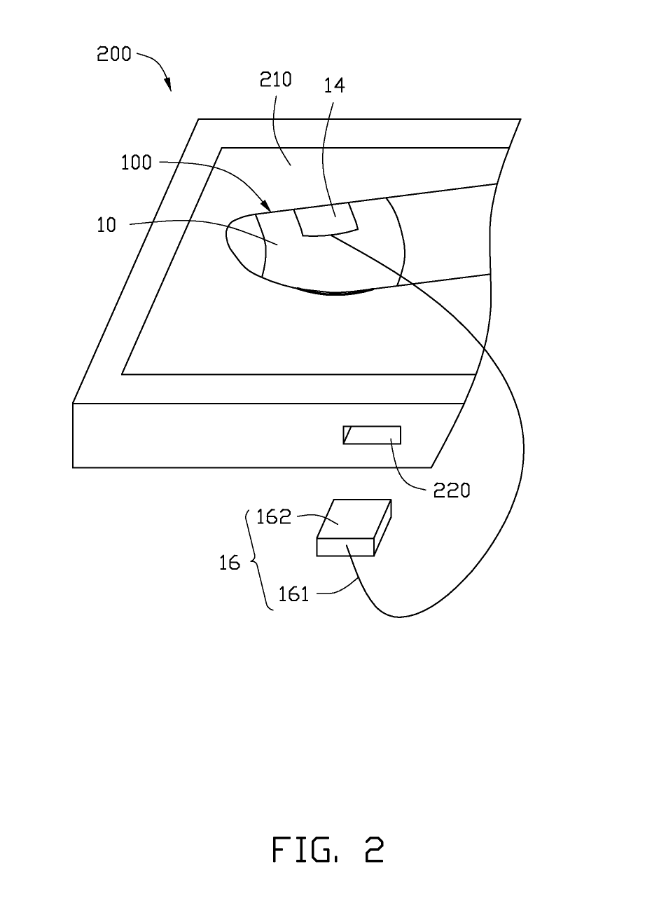

FIG. 2 illustrates a diagrammatic view of a portable electronic device 200 employing the finger-mounted touch panel actuator 100. The portable electronic device 200 includes a touch panel 210 that is configured to display various operation sections by display switching, and enable a predetermined operation input by touching the displayed operation sections. The portable electronic device 200 is configured to generate a vibrating signal. The vibrating signal can be generated in response to the touch of the finger-mounted touch panel actuator 100. The vibrating signal can also be generated in response to another triggering event, such as a game event.

The finger-mounted touch panel actuator 100 is further provided with a vibrator 14, and a transmission module 16 electronically coupled between the vibrator 14 and the electronic device 200. The transmission module 16 is configured to receive the vibrating signal from the portable electronic device 200, and transmit the vibrating signal to the vibrator 14. The vibrator 14 is disposed to the sleeve 10, and is configured to vibrate in response to the vibrating signal, such that, when the user touches the touch panel 210 by the finger-mounted touch panel actuator 100, the user can sense the vibration of the finger-mounted touch panel actuator 100 simultaneously.

In at least one embodiment, the transmission module 16 includes a connector 162 and a transmitter, such as a cable 161 electronically coupled between the connector 162 and the vibrator 14. The portable electronic device 200 includes a connector 220 mating with the connector 162. The connector 162 can be detachably attached to the connector 220 to receive the vibrating signal and obtain power from the portable electronic device 200 to the vibrator 14. The connectors 162 and 220 are preferred to be USB connectors.

In use, the sleeve 10 is positioned over the finger of the user through the entrance 11.

Contact with the touch panel 210 can be made by the user with the first and/or second protrusions 121 and 123 to create a touch point. The portable electronic device 200 enables a predetermined operation input by the touch of the first and/or second protrusions 121 and 123, and generates a vibrating signal in response to the touch of the first and/or second protrusions 121 and 123. As a result, the user can sense the vibration of the vibrator 14 in response to the vibrating signal, thus an operation experience is improved. In addition, the first and second protrusions 121 and 123 are arranged to cooperatively serve as a direction instructing switch (cross key) of a game apparatus, thus it is very convenient for the user to operate a cross key operation sections of a game interface displayed on the touch panel 210.

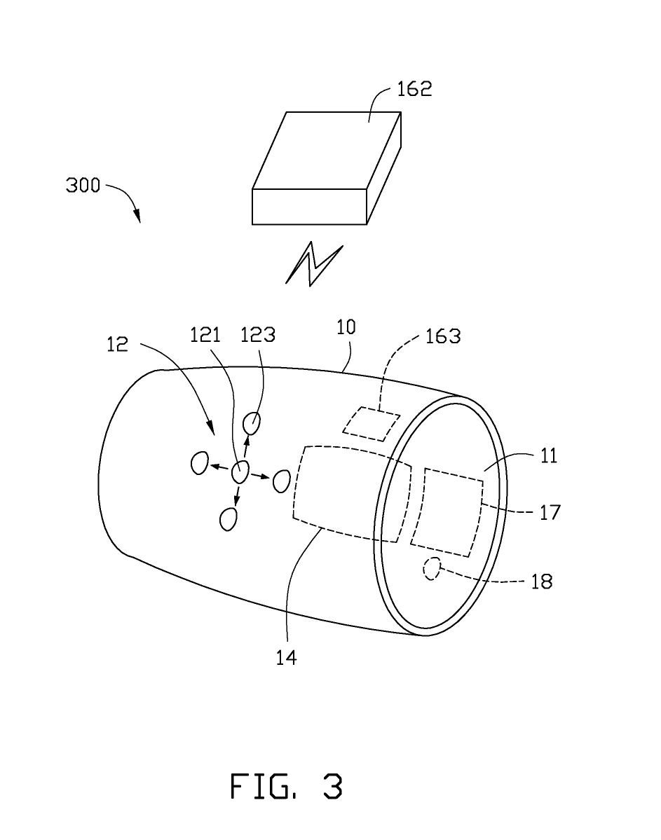

FIG. 3 illustrates an isometric view of a finger-mounted touch panel actuator 300 according to a second embodiment. The finger-mounted touch panel actuator 300 differs from the finger-mounted touch panel actuator 100 only in that: the finger-mounted touch panel actuator 300 further comprises a battery 17, an indictor 18. In addition, the cable 161 of the finger-mounted touch panel actuator 100 in FIG. 1 is replaced by a wireless communication unit 163. The battery 17 is attached into the sleeve 10, and electronically coupled to the vibrator 14 to power the vibrator 14. The indicator 18 is electronically coupled to the battery 17, to indicating power usage of the battery 17. The wireless communication unit 163 can make a wireless communication with the connector 162 to receive the vibrating signal from the portable electronic device 200 through the connector 162. It can be understood that, in another embodiment, the connector 162 can be omitted, and the wireless communication unit 163 can communicate with the portable electronic device 200 by Bluetooth protocol.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A finger-mounted touch panel actuator comprising:
a sleeve with an inner surface and an outer surface, having at least one protrusion extending from the outer surface of the sleeve; and
a vibrator configured to selectively vibrate the sleeve;
wherein, the sleeve is wearable by a user of the touch panel and the user may selectively touch the touch panel with the at least one protrusion;
wherein, the vibrator vibrates the sleeve in response to a vibrating signal generated by a n electronic device having the touch panel.

2. The finger-mounted touch panel actuator of claim 1, wherein the vibrating signal is generated when the at least one protrusion touches the touch panel.

3. The finger-mounted touch panel actuator of claim 1, further comprising:
a connector connectable to an electronic device with a touch panel; and
a transmitter configured to electronically transmit signals from the connector to the vibrator;
wherein, when the connector is connected to the electronic device with the touch panel, the vibrating signal is receivable by the connector and transmittable by the transmitter to the vibrator.

4. The finger-mounted touch panel actuator of claim 3, wherein the connector is a USB connector, and further configured to obtain power from the portable electronic device, and transmit the power to the vibrator.

5. The finger-mounted touch panel actuator of claim 3, wherein the transmitter is one of a cable and a wireless communication unit.

6. The finger-mounted touch panel actuator of claim 1, further comprising:
a battery electronically coupled to the vibrator and configured to power the vibrator; and
an indicator electronically coupled to the battery to indicate power usage of the battery.

7. The finger-mounted touch panel actuator of claim 1, wherein the sleeve and the at least one protrusion are made of elastic conductive material.

8. The finger-mounted touch panel actuator of claim 1, wherein the sleeve has a first protrusion and four second protrusions surrounding the first protrusion and arranged into a square, the first protrusion is centrally positioned in the square.

9. The finger-mounted touch panel actuator of claim 8, wherein two of the four second protrusions are located transversely with respect to the sleeve, the other two of the four second protrusions are located longitudinally with respect to the sleeve.

10. A finger-mounted touch panel actuator comprising:
a sleeve with an inner surface and an outer surface, having at least one protrusion extending from the outer surface of the sleeve;
wherein, the sleeve is wearable by a user of the touch panel and the user may selectively touch the touch panel with the at least one protrusion; and
wherein, the sleeve and the at least one protrusion are made of elastic conductive material.

11. The finger-mounted touch panel actuator of claim 10, wherein the sleeve has a first protrusion and four second protrusions surrounding the first protrusion and arranged into a square, the first protrusion is centrally positioned in the square.

12. The finger-mounted touch panel actuator of claim 11, wherein two of the four second protrusions are located transversely with respect to the sleeve, the other two of the four second protrusions are located longitudinally with respect to the sleeve.

13. The finger-mounted touch panel actuator of claim 10, further comprising:
a vibrator configured to selectively vibrate the sleeve;
wherein, a vibrating signal is generated when the at least one protrusion touches the touch panel; and
wherein, the vibrator vibrates the sleeve in response to the vibrating signal.

14. The finger-mounted touch panel actuator of claim 13, further comprising:
a connector connectable to an electronic device with a touch panel; and
a transmitter to electronically transmit signals from the connector to the vibrator;
wherein, when the connector is connected to the electronic device with the touch panel, the vibrating signal is receivable by the connector and transmittable by the transmitter to the vibrator.

15. The finger-mounted touch panel actuator of claim 14, wherein the connector is a USB connector, and further configured to obtain power from the portable electronic device, and transmit the power to the vibrator.

16. The finger-mounted touch panel actuator of claim 14, wherein the transmitter is one of a cable and a wireless communication unit.

17. The finger-mounted touch panel actuator of claim 10, further comprising:
a battery electronically coupled to the vibrator and configured to power the vibrator; and
an indicator electronically coupled to the battery to indicate power usage of the battery.
